(19) United States
(12) Patent Application Publication
(10) Pub. No.: US 2007/0055740 A1
(43) Pub. Date: Mar. 8, 2007

(54) System and method for interacting with a remote computer

(76) Inventors: Luis E. Luciani, Tomball, TX (US); Theodore F. Emerson, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/209,579

(22) Filed: Aug. 23, 2005

(51) Int. Cl. G06F 15/16

(52) U.S. Cl. 709/217

(57) ABSTRACT

There is provided a system and a method for interacting with a remote computer. More specifically, there is provided a method comprising transmitting a command to a first computer, wherein the command is associated with a virtualized control displayed on a second computer, and displaying a hardware status indicator on a display of the second computer after the first computer executes the transmitted command, wherein the hardware status indicator is a graphical representation of an external visual indicator of the first computer.

### BACKGROUND

This section is intended to introduce the reader to various aspects of art, which may be related to various aspects of the present invention that are described and claimed below. This discussion is believed to be helpful in providing the reader with background information to facilitate a better understanding of the various aspects of the present invention. Accordingly, it should be understood that these statements are to be read in this light, and not as admissions of prior art.

As most people are aware, computers and computer networks continue to play an increasingly important role in society. From small scale office networks to large scale networks, such as the Internet, it cannot be denied that computer networks play an important part in global communications and information systems. At the heart of computer networks are the computers themselves. Even though computers in general have become much more reliable over the past few years, most computers still benefit from periodic maintenance, updates, or repairs. Until a few years ago, the more prevalent technique for performing this maintenance was for a technician to sit down in front of a particular computer and use the particular computer's keyboard, mouse, or disk drives to perform the maintenance. Several years ago, however, many types of computers began to leverage computer networks to enable technicians to perform maintenance or monitoring remotely from another computer somewhere else on the computer network.

### BRIEF DESCRIPTION OF THE DRAWINGS

Advantages of the invention may become apparent upon reading the following detailed description and upon reference to the drawings in which:

FIG. 1 is a block diagram of an exemplary computer network configured to display hardware status data on a remote computer in accordance with an exemplary embodiment of the present invention;

FIG. 2 is a flow chart illustrating an exemplary technique for interacting with a remote computer in accordance with an exemplary embodiment of the present invention;

FIG. 3 is a flow chart illustrating another exemplary technique for interacting with a remote computer in accordance with an exemplary embodiment of the present invention;

FIG. 4 is a diagram illustrating an exemplary graphical control panel in accordance with an exemplary embodiment of the present invention; and

FIG. 5 is a flow chart illustrating an exemplary technique for mounting remote storage to a host computer in accordance with an exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The exemplary embodiments described below are directed towards a system or a method for interacting with a remote computer. For example, in one embodiment, a host computer contains a circuit that is configured receive commands from a remote computer and to transmit status data associated with the host computer hardware to the remote computer. In another embodiment, a remote computer is configured to create a graphical control panel, to receive hardware status data generated by host computer hardware, and to display the status data in the graphical control panel.

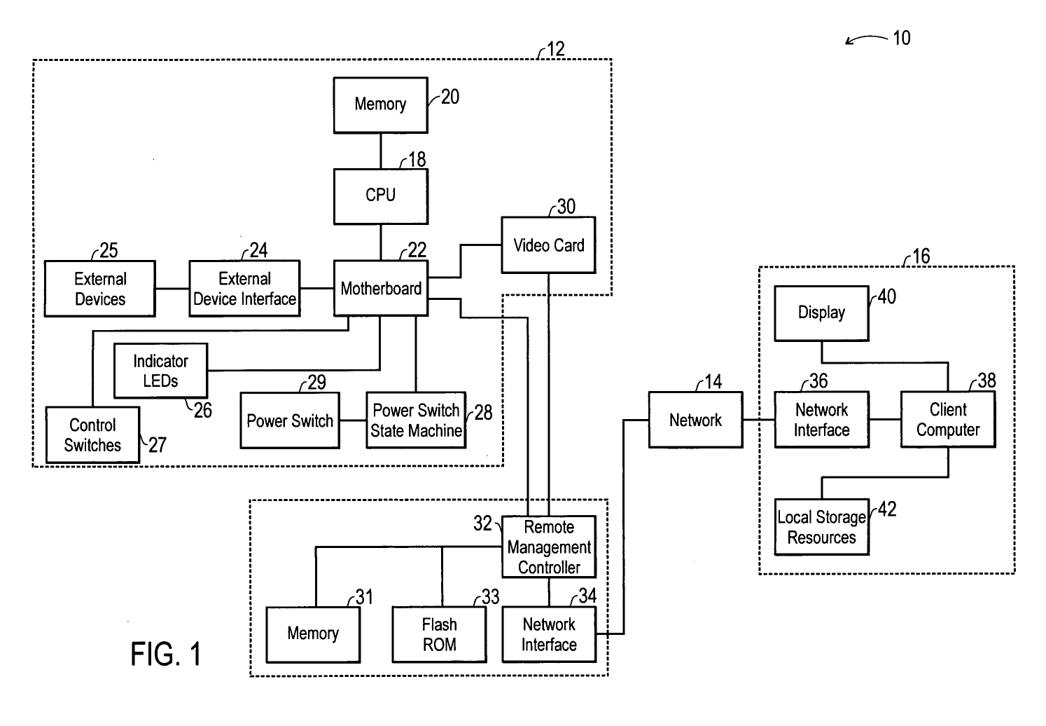

Turning initially to FIG. 1, a block diagram of an exemplary computer network configured to display hardware status data on a remote computer in accordance with an exemplary embodiment is illustrated and generally designated by a reference numeral 10. As illustrated, the computer network 10 may include a host computer 12, a network 14, and a remote computer 16, referred to as the remote computer 16. In one embodiment, the host computer 12 is a modified version of the ProLiant DL 380 server manufactured by Hewlett-Packard Company, the network 14 is an Ethernet network, and the remote computer 16 is an HP Compaq nx9600 Notebook PC also produced by Hewlett-Packard Company.

The host computer 12 may include one or more central processing units (“CPU”) 18. The CPUs 18 may be any suitable number of physical or logical CPUs, such as the Intel Pentium IV Processor or the Intel Xeon Processor. The CPUs 18 may be configured to execute instructions stored on a host memory 20. For example, in one embodiment, the CPUs 18 may execute instructions stored on the memory 20 to route data across the network 14.

The CPU 18 may be coupled to a motherboard 22 of the host computer 12. In one embodiment, the motherboard 22 controls the routing of signals and instructions within the host computer 12. The motherboard 22 may be coupled to an external device interface 24, indicator light emitting diodes (“LEDs”) 26, control switches 27, and a power switch state machine 28. The external device interface 24 may be any suitable form of computer interface. For example, the external device interface 24 may be a Peripheral Components Interconnect (“PCI”) interface, a PCI-X interface, a PCI Express interface, a Fibre channel interface, a fiber optic interface, a Small Computer System Interface (“SCSI”), an Ethernet interface, a Universal Serial Bus (“USB”) interface, a Firewire interface, a Fibre-SCSI interface, a Serial Advance Technology Attachment (“SATA”) interface, a Serial Attached SCSI (“SAS”) interface, and so forth. As illustrated in FIG. 1, the external device interface 24 may be coupled to one or more external devices 25, such as a storage device, a network interface, etc.

The indicator LEDs 26 enable the host computer 12 to display visually one or more status indicators without using a computer monitor. For example, in one embodiment, the indicator LEDs may illuminate to indicate access to a storage device, access to a network, an error or failure of the host computer 12, and so forth. In another embodiment, the indicator LEDs 26 may be configured to display power-on self test (“POST”) codes or other milestone codes emitted by the host computer during the boot process. In still another embodiment, the indicator LEDs may display the power state of the host computer 12 (e.g., on, standby, sleep, hibernate, off, and the like).

The control switches may permit a user to interface or send commands to the motherboard 22. For example, the control switches 27 may include a sleep button that, when pressed, causes the motherboard 22 to initiate a lower power state. The control switches 27 may also include a non-maskable interrupt (“NMI”) dump switch that, when activated, causes the motherboard 22 to initiate a non-maskable interrupt dump to cause a Windows™ blue screen. In still other embodiments, the control switches 27 may include a unit identification switch (“UID”) that, when activated, causes the motherboard 22 to illuminate an LED or other externally mounted light source so that a user can visually identify the host computer 12 amongst a plurality of other computers. These examples are not intended to be exclusive.

As will be appreciated, the power switch 29 may allow a user to power-on or power-off the host computer 12. In one embodiment, the power switch 29 is a momentary contact switch. The momentary press of the power switch 29 is fed into the power switch state machine 28 that performs the desired power-button functionality and supplies the power supply with an on/off signal. As illustrated, the power switch state machine 28 is coupled to the motherboard and thus may be tied into operating system (“OS”) software running on the host computer 12. When the user presses the power switch 29 while the power switch 29 is under control of a power-management aware OS running on the host computer 12, a signal is generated to inform the OS of the user's desire for a power-down event. The OS then starts a graceful shutdown of the machine and when all data is quiesced, the OS itself turns off power through a register located in the power control logic. If the OS is degraded or otherwise in a state where a graceful shutdown is not possible, a user may also be able to “force” a power-down by pressing in the power switch 29 and holding it for a time period. The power switch state machine 28 may see this condition and de-asserts the “on” request to the power-supply.

Those of ordinary skill in the art will also appreciate that even when the host computer 12 is powered off, the host computer 12 may still draw some power. For example, the host computer 12 may continue to draw power for standby purposes, such as maintaining the host computer's internal clock or powering a remote management controller 32, as will be discussed further below.

The motherboard 22 may also be coupled to a video card 30. The video card 30 may be configured to receive video display data from the motherboard 22 and to transmit that video display data to a monitor (not shown) for display to a user. In one embodiment, the video card is configured to transmit a digital video data. For example, the video card 22 may be configured to produce a digital video output (“DVO”).

As illustrated, the motherboard 22 and/or the video card 30 may be coupled to the remote management controller (“RMC”) 32. In one embodiment, the RMC 32 may be an expansion or add-in card coupled to the digital video output of the video card 30 and coupled to the motherboard 22 via an expansion port, such as a PCI expansion port. In another embodiment, the RMC 32 may include a logic circuit, such as an ASIC, Field Programmable Gate Array (“FPGA”), and the like mounted on the motherboard 22, itself. In yet another embodiment, the RMC 32 may be a self-contained internal or external unit is coupled directly to one or more components of the host computer 12. The RMC 32 may be coupled to a network 14, such as an intranet or the Internet via a network interface 34. In one embodiment, the network interface 34 may be a dedicated network interface for the RMC 32. In an alternate embodiments (not shown), the RMC 32 and the motherboard 22 may share a single network interface.

In one embodiment, the RMC 32 (in combination with the network 14 and the remote computer 16) may form a remote management system for the host computer 12. Further, in one embodiment, the RMC 32 may be a part of an integrated lights out (“iLO”) system for managing servers that are located in temperature-controlled dark rooms, for example. Because technicians generally are not intended to enter these rooms, the RMC 32 in combination with the network 14 and the remote computer 16 may enable management and maintenance of these types of servers. As such, the RMC 32 and its related components may include auxiliary power sources, such as batteries (not shown) or may be configured to draw power from the host computer's 12 power source when the host computer 12 is turned off. In this way, the RMC 32 may enable the host computer 12 to be managed through the RMC 32 even when the host computer 12 is turned off.

As will be described in greater detail below, the RMC 32 may be configured to receive status data regarding the state of visual indicators associated with one or more the external devices 25, the indicator LEDs 26, and/or the power state of the host computer 12. The RMC 32 may also be configured to transmit this status data, referred to as hardware status data, to the remote computer 16 over the network 14. The RMC 32 may also be configured to store a graphical control panel that can be transmitted to the remote computer 16 to enable the remote computer 16 to display the hardware status data graphically. Further, the RMC 32 may be configured to receive commands or instructions from the remote computer 16 and to transmit these commands or instructions to the motherboard 22 or other suitable components of the host computer 12.

Returning now to FIG. 1, the RMC 32 on the host computer 12 may be coupled to a memory 31 and a flash read-only memory (“ROM”) 33. In one embodiment, the flash ROM may be configured to store operating instructions for the RMC 32, which can be copied to the memory 31, such a random access memory (“RAM”), to enable the RMC 32 to perform the functions described herein. In one embodiment, the instructions stored on flash memory 33 may be upgraded or replaced to upgrade or change the configuration of the RMC 32.

The RMC 32 may be communicatively coupled to the remote computer 16 via the network 14. As outlined above, the network 14 may be any form of computer network suitable to link the RMC 32 with the remote computer 16. For example, the network may be an Ethernet network, a Gigabit network, a wireless network, and so forth.

The remote computer 16 may include the network interface 36, a client computer 38, a display 40, and local storage resources 42, such as an optical drive, a hard disk drive, and/or a semiconductor memory. In one embodiment, the client computer 38 is configured to execute a graphical control panel program that produces virtualized controls that enable a user of the remote computer 16 to transmit commands to the host computer via the RMC 32. Further, the graphical control panel program may also enable the client computer 38 to display status data regarding the host computer 12 on the display 40, wherein the graphical control panel program and/or the status data is received from the RMC 32 over the network 14. In another embodiment, the remote computer 16 may also be configured to display video display data from the video card 30 on the display 40. In still another embodiment, the client computer 38 may be configured to logically couple or “mount” local storage resources 42, such as disk drives or image files to the host computer 12 via RMC 32, as described in further detail in regard to FIG. 5.

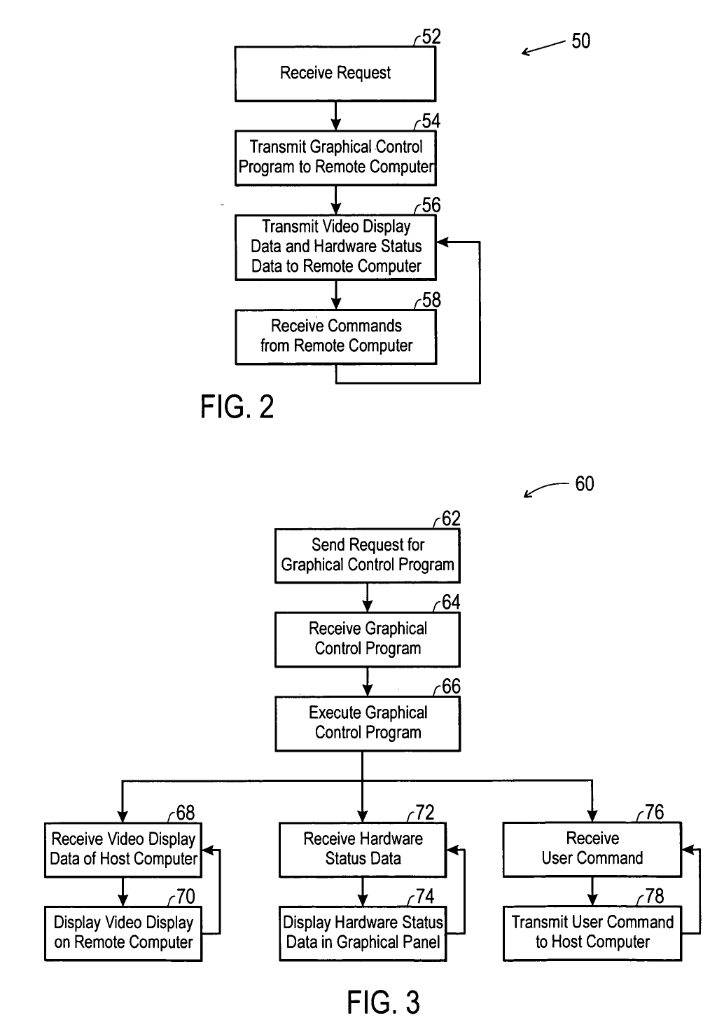

As described above, embodiments of the present technique enable the creation of a graphical control panel on the remote computer 16. The graphical control program may enable the remote computer 16 to create a graphical user interface (“GUI”) that includes virtualized controls that enable a user of the remote computer 16 to transmit commands and/or instructions to the host computer 12 via the RMC 32. The GUI may also display video display data and/or hardware status data from the host computer 12. Specifically, in one embodiment, the graphical control panel may be configured to display graphically hardware status data associated with the host computer 12 that the RMC 32 transmits over the network 14. Accordingly, FIG. 2 is flowchart illustrating an exemplary technique 50 for interacting with the remote computer 16 in accordance with one embodiment. In one embodiment, the technique 50 is executed by a gate structure, logic that is configured to execute instructions, or another component within the RMC 32.

As indicated by block 52, the technique 50 begins when the RMC 32 receives a request from the remote computer 16 to create a graphical control panel for the host computer 12. In one embodiment (not shown), the RMC 32 may prompt the remote computer for a password or other form of authentication to ensure that the remote computer 16 has permission to access the hardware status data of the host computer 12. After receiving the request from the remote computer 16 (and authenticating it, if appropriate), the RMC 32 may transmit a graphical control program to the remote computer via the network 14, as indicated in block 54. In various embodiments, the graphical control program may be an Active-X control, a Java applet, a .NET framework program, or other suitable form of software and/or instructions. It should be noted, however, that in alternate embodiments the graphical control program may also be preloaded on the remote computer 16.

Once the RMC 32 has transmitted the graphical control program to the remote computer 16 and once the remote computer has begun to execute the graphical control program, the RMC 32 may begin to transmit video display data from the video card 30 to the remote computer 16 via the network 14, as indicated in block 56. In one embodiment, the RMC 32 may compress the video display data to facilitate transmission over the network 14. Various compression techniques may be employed.

Either after the video display data is transmitted or while the video display data is begin transmitted, the RMC 32 may also transmit hardware status data to the remote computer 16, as also indicated in block 56. For example, the RMC 32 may transmit the power state of the host computer 12 (e.g., on, standby, or off), the status of one of the indicator LEDs 26 (i.e., illuminated or not illuminated), a status of one or more of the external devices 25, and/or a status of the local storage resources 42. As alluded to above, because the RMC 32 may have an independent power source, the RMC 32 is able to transmit both the video display data and the status data regardless of the state of the host computer 12. For example, if the host computer is in the off state, the RMC 32 may be configured to transmit to the remote computer 16 an indication that there is no current video display data and an indication that the power state of the host computer 12 is “off.”

As described above, the graphical control panel may also contain one or more virtualized controls. As such, the RMC 32 may also be configured to receive commands from the remote computer 16 and to transmit those commands to the host computer 12, as indicated by block 58. For example, the graphical control panel may include a virtualized power switch, that when activated (by a mouse click, for example) may cause the graphical control panel to transmit a power-related command to the RMC 32. In one embodiment, the virtualized power switch may be configured to perform a soft reset if the virtualized power switch is clicked on relatively briefly and to perform a hard reboot if the virtualized power switch is clicked on longer. As described in more detail below, the RMC 32 may also receive commands related to control switches 27 or commands involving the local storage resources 42. In one embodiment, the RMC 32 may use multiple ports (TCP/IP ports, for example) to simultaneously transmit and receive commands, display data, and status data.

Further, as illustrated in FIG. 2, the RMC 32 may be configured to repeat blocks 56 and 58 periodically or as the video data and/or status data for the host computer 12 changes or as new commands are transmitted from the remote computer 16. In one embodiment, the RMC 32 is configured to identify any changes to either the video display data or the status data and to transmit updates accordingly. For example, rather than continually transmit the status or the indicator LEDs 26 or the power state of the host computer 12, the RMC 32 may be configured to transmit updated status data when one of the statuses changes. In an alternate embodiment, the RMC 32 transmits a continual or near continual stream of video display data and/or status data.

As described above, the RMC 32 may be configured to transmit a graphical control program, video display data, and/or hardware status data to the remote computer 16. FIG. 3 is a flow chart illustrating an exemplary technique 60 that the remote computer 16 may perform to interact with the RMC 32 in accordance with one embodiment. In various embodiments, the technique 60 may be executed by modules, components, and/or gate structures within the remote computer 16. As indicated by block 62, the technique 60 begins with the remote computer 16 sending a request to download the graphical control program to the RMC 32. In one embodiment, sending the request to download the graphical control program may involve logging into the RMC 32 via the network interface 14.

Next, the remote computer 16 may receive the graphical control program from the RMC 32, as indicated by block 64. After the remote computer 16 has received the graphical control program, it may execute the graphical control program, as illustrated by block 66. At this point in the technique 60, the remote computer 16 may begin to receive the video display data of the host computer 12, as indicated by block 68. Once received, this video display data may be displayed on the display 40 of the remote computer 16. In one embodiment, the remote computer is configured to display the video display data from the host computer in a format matching the native display of the host computer. For example, if the native resolution of the video card 30 is 1024 by 768, the remote computer 16 may be configured to display the video display data at full screen with a resolution of 1024 by 768. In an alternate embodiment, the remote computer 16 may be configured to display the video display data in a subset of the display 40 or a different resolution than the host computer's 12 native resolution. Further, as illustrated in FIG. 3, the remote computer 16 may be configured to periodically loop back to block 68 to ensure that the remote computer receives updated video display data from the RMC 32.

The remote computer 16 may also be configured to receive and display hardware status data from the RMC 32, as indicated in blocks 72 and 74. In one embodiment, the hardware status data may include hardware status indictors that are typically externally visible on the host computer 12, such as the condition of the external indicator lights on the host computer 12, the power state of the host computer 12, and/or the status of storage devices coupled or mounted to the host computer 12. Further, as illustrated in FIG. 3, the remote computer 16 may be configured to loop back to block 72 to ensure that updates to the hardware status data are displayed in the graphical control panel.

The remote computer 16 may also be configured to receive user commands from the user of the remote computer 16, as indicated by block 76. In one embodiment, the user command may come from a keyboard and/or mouse coupled to the remote computer 16. In another embodiment, the user requests may come from user interaction with the virtualized controls within the graphical control panel. For example, the user may click on a virtualized power control to issue a power-related command. The user may also click on a virtualized control to command one or more of the local storage resources to be communicatively coupled to the host computer 12. The user may also click on a virtualized control to initiate a non-maskable interrupt on the host computer 12 or to activate a unit identification (“UID”) light on the host computer 12. It will be appreciated that these examples of virtualized controls are merely exemplary and not intended to be exclusive. For example, in alternate embodiments, the virtualized controls may include any function suitable for one of the control switches 27. Once the host computer 16 has received the user request, it may transmit the request to the host computer 12 via the RMC 32, as indicated by block 78. Further, as illustrated in FIG. 3, the remote computer 16 may be configured to periodically loop back to block 76 as new commands are received.

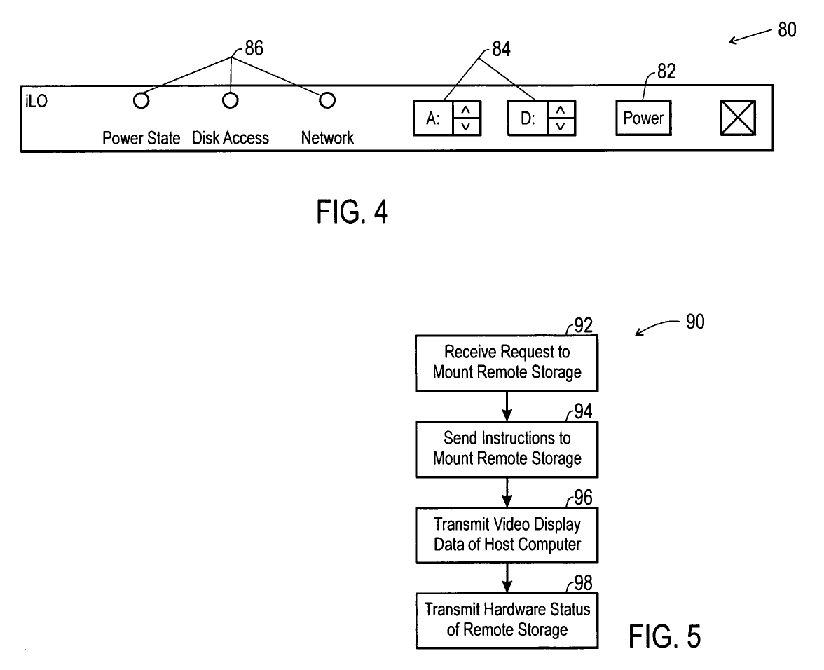

As such, the remote computer 16 is configured transmit commands to the host computer 12 while the remote computer 16 is receiving hardware status data and video display data from the host computer 12 (blocks 68 and 72). For example, if the user “presses” a virtualized power switch control on a graphical control panel 80 (see FIG. 4), the graphical control program may transmit a command to the motherboard 22 to have the power switch state machine 28 de-assert the “on” request to the power supply. The user will then be able to observe the display effects and the hardware effects of that action on the host computer 12 in relative real-time (blocks 68-74). Specifically, the user will be able to observe the display data of the host computer being generated by the host computer 12 and will be able to see the hardware status indicators, such as the state of the power switch, the state of the indicator LEDs 26, and so forth. As such, the system 10 can simulate a closed-loop experience of sitting in front of the host computer 12 for the user of the remote computer 16, because the user of the remote computer 16 is able use virtualized controls that simulate the actual controls of the host computer 12 (e.g., the control switches 27) and then is able to see both the display data and the hardware effects of those commands on the host computer 12. In other words, the user of the remote computer can interact with the host computer 12 in the same manner and with the same indicators that the user would have if they were physically sitting at a terminal directly in front of the host computer 12.

As described above, the remote computer 16 may be configured to execute the graphical control program to create a GUI that enables interaction with the host computer 12 via the RMC 32. In one embodiment, the remote computer 16 may generate a GUI containing a graphical control panel, such as the graphical control panel 80 illustrated in FIG. 4. As illustrated in FIG. 4, the graphical control panel 80 may include a virtualized control 82 of power switch 29, a virtualized control/representation 84 of storage devices coupled or mounted to the host computer 12, and a representation 86 of the indicator LEDs 26. It will be understood, however, that the graphical control panel 80 is merely one exemplary embodiment of the graphical control panel 80 and not intended to be exclusive. As such, in alternate embodiments, other suitable graphical representations may be included in the graphical control panel 80. For example, the graphical control panel may also include a virtualized NMI button, a virtualized unit identification button, or any other suitable virtualization of one of the control switches 27.

The remote computer 16 may render the graphical control panel 80 over the video display data from the host computer 12 or may render the graphical control panel 80 along side the video display data. It will be appreciated that the one or more of the virtualized controls/representations 82, 84, or 86 may be designed to simulate the physical properties of actual components on the host computer 12. For example, the representation 82 of the power switch 29 may be configured to appear “pressed in” when the host computer 12 is powered on. Similarly, the representations 86 of the indicator LEDs 26 may appear illuminated when the actual indicator LEDs 26 are or would be illuminated.

As described above, the graphical control panel may be configured to include the virtualized control/representation 84 of storage devices coupled to or mounted to the host computer 12. The virtualized control/representation 84 may provide a selectable list of the local storage resources 42 that enables a user to couple one or more of the local storage resources 42 to the host computer 12. In one embodiment, the RMC 32 may be configured to mount one or more of the local storage resources 42 (e.g., hard disk drives, optical drives, or image files) as storage devices for the host computer 12 after receiving a mounting command from the remote computer 16.

FIG. 5 is a flow chart illustrating an exemplary technique 90 for mounting remote storage to the host computer 12 in accordance with one embodiment. In one embodiment, gate structures or components with the RMC 32 are configured to perform the technique 90. As indicated by block 92, the technique 90 begins with the RMC 32 receiving a request from the remote computer 16 to mount one of the remote computer's local storage resources 42 to the host computer 12. After receiving the request, the RMC 32 may send instructions to the motherboard 22 or a host controller (not shown) coupled to the motherboard to integrate (or mount) the local storage resource 42 into the file system of the host computer 12. In one embodiment, the motherboard 22 may be configured to treat the mounted local storage resource 42 as if it had been coupled to the motherboard 22 through the external device interface 24. For example, if a hard drive from the remote computer were mounted to the host computer 12, it might appear from the host computer's 12 perspective that the remote hard drive were being physically plugged into a USB or I.E.E.E. 1394 port on the host computer 12. Even though the remote hard drive is not physically plugged into the USB or I.E.E.E. 1394 port, the RMC 32 is configured to simulate this type of data connection for the host computer 12. In other words, data transfers from the host computer 12 for the remote hard drive may be sent to the remote hard drive via the RMC 32 and vice-versa. As such, the RMC 32 enables the motherboard 22 to access the mounted local storage resources 42 in the same manner that the motherboard 22 would access one of its own external storage devices 25 or internal storage devices (not shown in FIG. 1).

Once the local storage resource 42 has been mounted, the RMC 32 may be configured to transmit the video display data from the host computer 96 to the remote computer 16, as indicated in block 96. In this way, a user of the remote computer 16 is able to see the effects of mounting the drive on host computer 12. For example, if a CD-ROM drive containing a executable program is mounted to the host computer 12, the user of the remote computer may be able to see the new drive being added into the host computer's 12 file system and may be able to see the host computer 12 execute or autorun the executable program stored on the CR-ROM. Moreover, the RMC 32 may also be configured to transmit the hardware status and/or indicator light status (e.g., a disk access light) of the mounted local storage resource 42 to the remote computer 16.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed:

1. A method comprising:
transmitting a command to a first computer, wherein the command is associated with a virtualized control displayed on a second computer; and
displaying a hardware status indicator on a display of the second computer after the first computer executes the transmitted command, wherein the hardware status indicator is a graphical representation of an external visual indicator of the first computer.

2. The method of claim 1, wherein transmitting the command comprises transmitting a command to mount a storage device to the first computer.

3. The method of claim 1, wherein displaying the hardware status indicator comprises displaying a graphical control panel that includes the hardware status indicator.

4. The method of claim 1, wherein transmitting the command comprises transmitting a command associated with a virtualized power switch, wherein the virtualized power switch is configured to either transmit a soft reset command or a hard reboot command depending on how long a user clicks on the virtualized power switch.

5. The method of claim 1, wherein transmitting the command comprises transmitting a command associated with a virtualized non-maskable interrupt dump switch.

6. A logic circuit comprising:
a first gate structure configured to transmit video data from a host computer to a remote computer; and
a second gate structure configured to transmit a hardware status indicator from the host computer to the remote computer, wherein the hardware status indicator is a graphical representation of an external visual indicator of the host computer.

7. The logic circuit, as set forth in claim 6, comprising:
a third gate structure configured to transmit a graphical control panel program to the remote computer, wherein the graphical control panel program, when executed, displays the hardware status indicator on the remote computer.

8. The logic circuit, as set forth in claim 6, wherein the first gate structure is configured to transmit digital video data from a digital video output of the host computer.

9. The logic circuit, as set forth in claim 6, wherein the second gate structure is configured to transmit the current power state of the host computer.

10. The logic circuit, as set forth in claim 6, wherein the second gate structure is configured to transmit the current state of a status indicator light emitting diode.

11. A method comprising:
receiving an instruction for a host computer;
transmitting the instruction to a remote management controller associated with the host computer;
receiving a hardware status indicator associated with the host computer from the remote management controller coupled to the host computer; and
displaying the hardware status indicator in a graphical control panel on a display of a remote computer communicatively coupled to the remote management controller.

12. The method, as set forth in claim 11, comprising:
receiving a graphical control panel program from the remote management controller; and
executing the graphical control-panel program, wherein the graphical control panel program is configured to create the graphical control panel.

13. The method, as set forth in claim 12, wherein receiving the hardware status indicator comprises receiving the power state of the host computer.

14. The method, as set forth in claim 12, wherein receiving the hardware status indicator comprises receiving the state of an indicator light emitting diode.

15. The method, as set forth in claim 12, wherein receiving the instruction for a host computer comprises receiving an instruction to mount a storage device to the host computer.

16. The method, as set forth in claim 12, wherein receiving the instruction for a host computer comprises receiving an instruction to perform a non-maskable interrupt dump on the host computer.

17. A method comprising:
receiving a request at a host computer to mount a storage resource of a remote computer;
sending instructions to a motherboard within the host computer to integrate the storage resource into a file system of the host computer, wherein the host computer is communicatively coupled to the remote computer through a remote management controller; and
relaying data between the host controller and the storage resource of the remote computer.

18. The method, as set forth in claim 17, wherein receiving a request at a host computer to mount a storage resource of a remote computer comprises receiving a request at a host computer to mount a disk drive coupled to the remote computer.

19. A remote management controller comprising:
a first gate structure configured to transmit video data from a host computer to a remote computer;
a second gate structure configured to transmit hardware status data from the host computer to the remote computer; and
a third gate structure configured to transmit a graphical control panel program to the remote computer, wherein the graphical control panel program, when executed, displays the hardware status data on the remote computer.

20. A method of upgrading a server comprising:
flashing a read only memory with instructions that enable a remote management controller to transmit a graphical control panel program to a remote computer,
wherein the graphical control panel program, when executed, displays hardware status data of the remote management controller's host computer, and
wherein the graphical control panel program enables the remote computer to receive video display data and hardware status data associated with the host computer.

21. A computer system comprising:
a remote computer operable to couple to a remote management controller of a host computer over a network and configured to receive information from the remote management controller indicative of whether the host computer is powered-on or powered-off; the remote computer further comprising:
logic operable to display the information as a virtual power switch, wherein the program logic is configured to display the virtual power switch on a screen of the remote computer in an on-configuration if the information indicates that the host computer is powered-on and to display the virtual power switch in an off-configuration if the information indicates that the host computer is powered-off, and
logic configured to send a power-off command to the remote management controller for the host computer in response to receiving a click on the virtual power switch while in the powered-on configuration.

22. The computer system of claim 21, further comprising:
logic configured to detect a click on the virtual power switch that exceeds a time threshold; and
logic configured to send a forced power-off command to the remote management controller for the host computer in response to detecting a click on the virtual power switch that exceeds the time threshold.

23. The computer system of claim 22, further comprising:
a host computer including a power switch state machine configured to store information indicative of whether the host computer is powered-on or powered-off; and
a remote management controller coupled to the host computer and further coupled to the remote computer, wherein the power switch state machine is configured to transmit the information to the remote management controller and further configured to receive power commands from the remote management controller.
